(19) United States
(12) Patent Application Publication
(10) Pub. No.: US 2015/0326936 A1
(43) Pub. Date: Nov. 12, 2015

(54) DISPLAY APPARATUS AND CONTROLLING METHOD THEREOF

(71) Applicant: SAMSUNG ELECTRONICS CO., LTD., Suwon-si (KR)

(72) Inventor: Bong-gil BAK, Suwon-si (KR)

(73) Assignee: SAMSUNG ELECTRONICS CO., LTD., Suwon-si (KR)

(21) Appl. No.: 14/588,739

(22) Filed: Jan. 2, 2015

(30) Foreign Application Priority Data
May 12, 2014 (KR) 10-2014-0056755

(51) Int. Cl. H04N 21/485; H04N 21/422; H04N 21/4223; H04N 21/482

(52) U.S. Cl. CPC H04N 21/485; H04N 21/482; H04N 21/42221; H04N 21/4223

(57) ABSTRACT

A display apparatus and a method thereof are provided. The method of controlling a display apparatus includes determining a user's location with reference to a display panel of the display apparatus, and displaying an on-screen display (OSD) menu or a partial screen at an area corresponding to the determined user's location.

### CROSS-REFERENCE TO RELATED APPLICATION(S)

This application claims priority from Korean Patent Application No. 10-2014-0056755, filed on May 12, 2014, in the Korean Intellectual Property Office, the entire disclosure of which is incorporated herein by reference.

### BACKGROUND

1. Field

Apparatuses and methods consistent with exemplary embodiments relate to a display apparatus and a method of displaying a partial screen, and more particularly, to a display apparatus that allows a user to use a partial screen more efficiently.

2. Description of Related Art

As display apparatuses continue to evolve, resolution of the display apparatuses continues to improve. For example, an Ultra High Definition (UHD) display apparatus has recently been introduced. There are multiple varieties of resolution of a UHD, for example, 3840×2160, 4096×3112, and the like. In addition to the resolution of a display apparatus improving, display units themselves are getting larger. Due to the increase in size of the display apparatus, it is easier for a user to watch a high definition image.

Most monitors and televisions include an on screen menu for making adjustments to a display thereof. This menu is often referred to as an on-screen display (OSD) menu, and is typically activated by pressing a menu button located on the side or front of your monitor or on a remote control. When the OSD appears on the screen, a user can navigate through the menu and make adjustments.

However, when the user chooses to display an OSD menu or a partial screen for using other contents such as a game or an application, the OSD menu or the partial screen is displayed only at a predetermined location regardless of the user's location. Accordingly, with respect to larger display apparatuses, it can be difficult for the user to view and use contents displayed on the OSD menu or the partial screen if a user is not positioned at an area corresponding to the displayed OSD menu or partial screen.

Accordingly, a technology which allows a display apparatus to display an OSD menu or a partial screen in consideration of a location of a user who is watching a display apparatus is desired.

### SUMMARY

One or more exemplary embodiments provide a display apparatus and method for controlling a location at which an OSD menu or a partial screen is displayed based on a location of a user.

According to an aspect of an exemplary embodiment, there is provided a method of controlling a display apparatus, including determining a user's location with reference to a display panel of the display apparatus, and displaying an on-screen display (OSD) menu or a partial screen at an area corresponding to the determined user's location.

The determining may include, in response to a remote control signal being received from a plurality of infrared (IR) signal receivers located at both sides of the display apparatus, comparing a time at which the signal is received at each of the plurality of IR signal receivers, and determining the user's location based on the comparing.

In response to a first IR signal receiver at a first side of the display apparatus receiving the remote control signal faster than a second IR signal receiver at a second side of the display apparatus receiving the remote control signal, by more than a threshold amount of time, the determining may include determining that the user is located in a direction of the first side, and in response to the second IR signal receiver receiving the remote control signal faster than the first IR signal receiver, by more than the threshold amount of time, the determining may include determining that the user is located at the second side of the display apparatus.

The determining may include photographing the user using a camera, and determining a location of the user by analyzing the photographed image of the user.

The determining may include sensing a distance to the user using at least one distance sensor, and determining a distance sensor that is closest to the user as a location of the user.

The method may further include adjusting a volume of an audio signal output from first and second speakers at both sides of the display apparatus based on a location of the user.

The displaying may include, in response to receiving a user command to display a setting menu while a main image is being displayed on an entire area of the display panel, displaying the setting menu on the partial screen.

The displaying may include, in response to receiving a user command to display an application while a main image is being displayed on an entire area of the display panel, displaying the application on the partial screen.

According to an aspect of another exemplary embodiment, there is provided a display apparatus including a display panel configured to display an image, a detector, and a controller configured to determine a user's location with reference to the display panel according to a result of a detection by the detector, and display an on-screen display (OSD) menu or a partial screen at an area corresponding to the determined user's location.

The detector may further include a plurality of infrared (IR) signal receivers, and the controller may, in response to a remote control signal being received from a plurality of IR signal receivers at both sides of the display apparatus, compare a time at which the signal is received at each of the plurality of IR signal receivers and determine a user's location based on the comparing.

The controller may, in response to a first IR signal receiver at a first side of the display apparatus receiving the remote control signal faster than a second IR signal receiver at a second side of the display apparatus receiving the remote control signal, by more than a threshold amount of time, determine that the user is located in a direction of the first side, and in response to the second IR receiver receiving the remote control signal faster than the first IR signal receiver, by more than the threshold amount of time, determine that the user is located at the second side of the display apparatus.

The detector may further include a camera, and the controller may control the camera to photograph the user, and determine a location of the user by analyzing the photographed image of the user.

The detector may further include at least one distance sensor, and the controller may sense a distance to the user using the at least one distance sensor, and determine a distance sensor closest to the user as a location of the user.

The apparatus may further include a plurality of speakers, and the controller may adjust a volume of an audio signal output from first and second speakers from among the plurality of speakers according to a location of the user.

The controller may, in response to receiving a user command to display a setting menu while a main image with respect to an entire area of the display panel is being displayed, display the setting menu on the partial screen.

The controller may, in response to receiving a user command to display an application while a main image is being displayed on an entire area of the display panel, display the application on the partial screen.

According to an aspect of another exemplary embodiment, there is provided an apparatus for processing an image, the apparatus including a detector configured to determine an area on a display, from among the plurality of areas, which corresponds to a location of a user, and a controller configured to output at least one of an on-screen display (OSD) menu and a partial screen at the area of the display that corresponds to the location of the user.

The controller may divide the display into the plurality of areas.

The controller may output the at least one of the OSD and the partial screen at only the area on the display which corresponds to the location of the user.

The controller may output audio to a speaker based on the area of the display which corresponds to the location of the user.

According to one or more exemplary embodiments, a user may more conveniently use a display apparatus because a location at which an OSD menu or a partial screen is displayed adapts based on the location of the user.

### BRIEF DESCRIPTION OF THE DRAWINGS

The above and/or other aspects will be more apparent by describing certain exemplary embodiments with reference to the accompanying drawings, in which:

FIG. 1 is a block diagram illustrating a display apparatus according to an exemplary embodiment;

FIG. 2 is a block diagram illustrating a display apparatus according to another exemplary embodiment;

FIG. 3 is a diagram illustrating a display apparatus including a plurality of infrared (IR) signal receivers according to an exemplary embodiment;

FIG. 4 is a diagram illustrating a display apparatus displaying an OSD menu at a predetermined location according to an exemplary embodiment;

FIG. 5 is a diagram illustrating a display apparatus displaying an OSD menu in consideration of a direction in which a user is located according to an exemplary embodiment;

FIG. 6 is a diagram illustrating a display apparatus displaying an application in consideration of a direction in which a user is located according to an exemplary embodiment;

FIG. 7 is a diagram illustrating a display apparatus displaying an OSD menu in consideration of a direction in which a user is located according to an exemplary embodiment;

FIG. 8 is a diagram illustrating a display apparatus including a camera according to an exemplary embodiment;

FIG. 9 is a diagram illustrating a photographing image of a user according to an exemplary embodiment;

FIGS. 10 and 11 are diagrams illustrating a display apparatus displaying an OSD menu in consideration of a direction in which a user is located;

FIG. 12 is a diagram illustrating a display apparatus including a plurality of speakers according to an exemplary embodiment;

FIG. 13 is a flowchart illustrating a method of a display apparatus displaying a partial screen according to an exemplary embodiment; and

FIG. 14 is a flowchart illustrating a method of controlling an OSD menu display location using a plurality of IR signal receivers included in a display apparatus according to an exemplary embodiment.

### DETAILED DESCRIPTION

Hereinafter, exemplary embodiments are described with reference to accompanying drawings. In the following description, same reference numerals are used for analogous elements when they are depicted in different drawings. The matters defined in the description, such as detailed construction and elements, are provided to assist in a comprehensive understanding of exemplary embodiments. Thus, it is apparent that one or more exemplary embodiments can be carried out without those specifically defined matters. Also, functions or elements known in the related art are not described in detail because they would obscure the exemplary embodiments with unnecessary detail.

In the present disclosure, relational terms such as first and second, and the like, may be used to distinguish one entity from another entity, without necessarily implying any actual relationship or order between such entities.

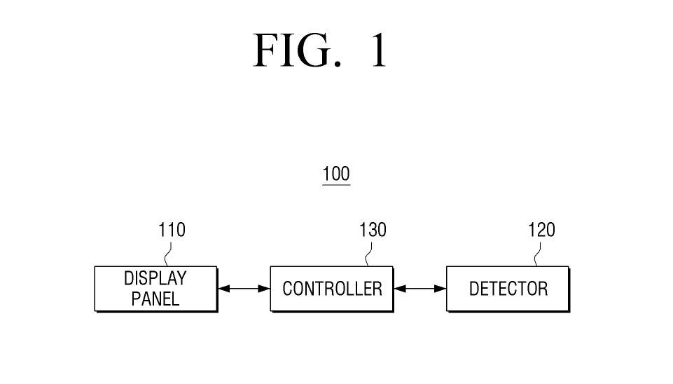

FIG. 1 is a block diagram illustrating a display apparatus 100 according to an exemplary embodiment. Referring to FIG. 1, the display apparatus 100 includes a display panel 110, a detector 120, and a controller 130. For example, the display apparatus 100 may be or may be connected to a television, a computer, a monitor, a tablet, a notebook computer, a game console, a set-top box, an appliance, and the like.

The display panel 110 may display an image. The display panel 110 may display content received through a broadcast channel. For example, the display apparatus 100 may receive various broadcast signals transmitted from a broadcasting station through a radio frequency (RF) communication network. As another example, the display panel 110 may receive content from various servers through an internet protocol (IP) network. Accordingly, the display panel 110 may display the received content.

The detector 120 may detect a user's location. For example, in order to display an OSD menu or a partial screen, the detector 120 may detect a user's location. The detector 120 may include one or more infrared (IR) signal receivers, and may receive a signal of an IR remote controller used by a user. The detector 120 may include a camera and may detect a user's location by photographing the user with the camera. As another example, the detector 120 may include one or more distance sensors that may detect a distance between the user and the display panel 110. Examples of detecting a user's location are further described herein.

The controller 130 may control the overall operations of the display apparatus 100. For example, the controller 130 may determine a user's location or a direction in which a user is located with reference to the display panel 110. In an example in which the detector 120 includes a plurality of IR signal receivers, the controller 130 may detect the user's location or the direction in which a user is located according to the order at which the plurality of IR signal receivers detect a signal of the remote controller. If the display apparatus 100 includes IR signal receivers on each side thereof, and a remote control signal is received through the IR signal receivers, the controller 130 may determine the direction at which the user is located by comparing the time when the signals are received. For example, if a first IR signal receiver on the first side of the display apparatus 100 receives a remote control signal prior to a second IR signal receiver on the second side of the display apparatus 100 receives a remote control signal, the controller 130 may determine that a user is located in the direction of the first side. For example, if the first IR signal receiver receives the signal a predetermined amount of time prior to the second IR signal receiver receiving the signal, the controller 130 may determine that the user is located on the first side. That is, the controller 130 may determine the difference in time in receiving the signals and compare the difference in time to a threshold amount of time.

Alternatively, if the first IR signal receiver on the first side of the display apparatus 100 receives a remote control signal after the second IR signal receiver on the second side of the display apparatus 100 receives a remote control signal, the controller 130 may determine that a user is located in the direction of the second side of the display apparatus 100.

As another example, if the difference in time between when the first IR signal receiver receives the signal and the second IR signal receiver receives the signal is less than or within a threshold amount of time, the controller 130 may determine that a user is located in a direction corresponding to the center of the display apparatus 100. In other words, if the time difference between when the first and second IR signal receivers receive the signal is within the threshold amount of time, the time difference between the first time and the second time may be determined as being trivial. Accordingly, if the time difference is within a threshold amount of time, the controller 130 may determine that a user is located towards the center of the display panel 110.

In addition, the detector 120 may include a camera. In this example, the controller 130 may determine a user's location or the direction in which a user is located by analyzing an image photographed by the camera. In other words, the controller 130 may determine a user's location or a direction at which a user is located with reference to a face of the user by analyzing the image photographed by the camera.

If the detector 120 includes a distance sensor, the controller 130 may determine the user's location or the direction at which a user is located according to what the distance sensor senses. The detector 120 may include a plurality of distance sensors. For example, the detector 120 may include three distance sensors in the lower part of the display panel 110 in a row and in a horizontal direction. The controller 130 may determine a direction in which a user is located based on a distance sensor, from among the plurality of distance sensors, which senses a user at the closest distance.

Based on the direction at which the user is located being determined, the controller 130 may control the display apparatus such that an OSD menu or a partial screen is displayed at an area of the screen corresponding to the determined direction, from among the entire area of the display panel. For example, the controller 130 may generate an OSD menu through an OSD menu generator, and control the display apparatus to display the generated OSD menu.

If a user command to display an OSD menu is input from a user while a main image is being displayed on a full area of a screen of the display panel 110, the controller 130 may control the screen to display the OSD menu. Alternatively, if a user command to display an application is input from a user while a main image is being displayed on a full area of a screen of the display panel 110, the controller 130 may control the screen to display the application on a portion of the screen.

For example, the controller 130 may divide the entire area of the display panel 110 into a plurality of areas such as three areas, and if it is determined that a user is located in a direction of a first side rather than the center or the second side, the controller 130 may control the screen such that a partial screen is displayed on an area corresponding to the direction of the first side. As another example, if it is determined that a user is located in a direction of a second side rather than the center or the first side, the controller 130 may control the screen such that a partial screen is displayed on an area corresponding to the direction of the second side. However, dividing the entire area of the display panel 110 into three areas is merely an example, and the display panel 110 may be divided into a plurality of areas depending on a setting or on a user input.

For example, depending on a setting, the display panel 110 may be divided into four areas or more, and the controller 130 may control the screen such that an OSD menu or a partial screen is displayed on one area from among the divided four areas in accordance with the determined user's location or direction at which a user is located. That is, such that the OSD menu or partial screen is only displayed on one area from among the plurality of areas of the screen.

However, displaying content such as a setting menu or an application through a partial screen is only an example, and depending on a user setting, a main image displayed on the full screen of the display panel 110 may be displayed on a partial screen.

The display apparatus 100 may further include a plurality of speakers. Accordingly, the controller 130 may adjust an output level of an audio signal output from the plurality of speakers in accordance with the determined user's location or direction at which a user is located. For example, if an image displayed on a partial screen includes an audio, the controller 130 may increase an audio signal (i.e., volume) output from the speaker which is adjacent to where the partial screen is located while maintaining, reducing, or otherwise preventing audio from being output from the other directions.

Alternatively, if an image displayed on a partial screen does not include an audio, the display apparatus 100 may output an audio signal of the entire image, and thus, the controller 130 may decrease an audio output signal of the speaker which is adjacent to the determined user's location or direction at which a user is located and increase an audio output signal of a speaker that is farther away.

According to the example display apparatus 100, a user may view an OSD menu or a partial screen which is displayed on an area adjacent to the user on the display panel 110 thereby improving a user convenience.

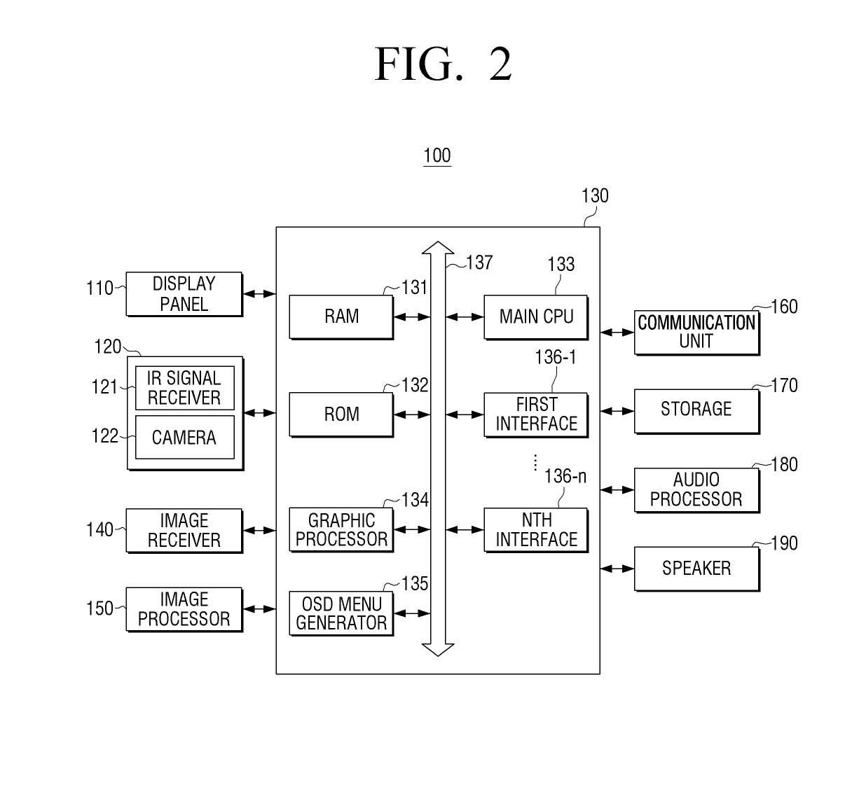

Hereinafter, an example of the display apparatus 100 is described in greater detail with reference to FIG. 2 according to an exemplary embodiment. As illustrated in FIG. 2, the display apparatus 100 includes the display panel 110, the detector 120, and the controller 130. In this example, the display apparatus 100 further includes an image receiver 140, an image processor 150, a communication unit 160, a storage 170, an audio processor 180, and a speaker 190.

The display apparatus 100 of FIG. 2 may be used to perform various functions such as a user-photographing function, a partial screen display function, an OSD menu providing function, a communication function, a moving image play function, a display function, and the like. It should also be appreciated that, depending on exemplary embodiments, some elements illustrated in FIG. 2 may be omitted or changed, and other elements may be added.

The display panel 110 may display an image. The display panel 110 may display content received through a broadcast channel. For example, the display panel 110 may display at least one of a video frame which is generated as the image processor 150 processes image data received from the image receiver 140 and various screens generated by a graphic processor 134. In addition, the display panel may display an OSD menu generated by an OSD menu generator 135 on an area of the screen.

The detector 120 includes an IR signal receiver 121, a camera 122, and the like. If a user inputs a command by pressing a button of an IR remote controller, the detector 120 may detect an IR signal transmitted by the IR remote controller. The display apparatus 100 may include a plurality of IR signal receivers 121. In this example, the display apparatus 100 may determine a user's location or direction at which a user is located based on the difference of time at which the IR signal receivers 121 receives an IR signal from the remote controller using the plurality of IR signal receivers 121.

However, the embodiment in which the display apparatus 100 includes the plurality of IR signal receivers 121 is only an example. As another example, the display apparatus 100 may determine the user's location or direction at which a user is located using a sensor that may sense the direction and distance of the user's location.

The camera 122 may photograph a user who is watching or viewing contents played by the display apparatus 100. Using an image of the user that is photographed by the camera 122, the controller 130 may determine a direction in which the user is located based on the photographed image of the user captured by the camera 122. Examples of determining the user's location or direction at which a user is located using what is detected by the IR signal receiver 121 or the camera 122 are further described herein.

The image receiver 140 may receive image data through various sources. For example, the image receiver 140 may receive broadcast data from an external broadcasting station, image data in real time from an external server, image data stored in the internal storage 170, and the like.

The image processor 150 processes image data received from the image receiver 140. For example, the image processor 150 may perform various image processing with respect to image data, such as decoding, scaling, noise filtering, frame rate conversion, resolution conversion, and the like.

The communication unit 160 performs communication with various types of external apparatuses according to various types of communication methods. For example, the communication unit 160 may include a WiFi module, a Bluetooth module, a Near Field Communication (NFC) module, and the like. The WiFi module, the Bluetooth module, and the NFC module perform communication according to a WiFi method, a Bluetooth method, and an NFC method, respectively. The NFC module represents a module which operates according to an NFC method which may use a 13.56 MHz band from among various RF-ID frequency bands such as 135 kHz, 13.56 MHz, 433 MHz, 860-960 MHz, 2.45 GHz, and so on. In the case of the WiFi module or the Bluetooth module, various connection information such as a service set identifier (SSID) and a session key may be transmitted/received first to establish a communication connection, and then, various information may be transmitted/received.

The storage 170 stores various modules that may be used to control the display apparatus 100. For example, the storage 170 may store various software including a base module, a sensing module, a communication module, a presentation module, a web browser module, a service module, and the like. In this case, the base module refers to a basic module which processes a signal transmitted from hardware included in the portable terminal 100, and transmits the processed signal to an upper layer module. The sensing module collects information from various sensors, and analyzes and manages the collected information. For example, the sensing module may include a face recognition module, a speech recognition module, a motion recognition module, an NFC recognition module, and the like. The presentation module composes a display screen. For example, the presentation module may include a multimedia module for reproducing and outputting multimedia contents, and a UI rendering module for UI and graphic processing. The communication module communicates with other devices. The web browser module accesses a web server to enable a user to perform web-browsing. The service module includes various applications for providing various services.

As described herein, the storage 170 may store various program modules, but some of the program modules may be omitted, changed, or other modules may be added depending on the type and characteristics of the display apparatus 100.

The storage 170 may also store an image photographed by the camera 122. As an example, if an image photographed by the camera 122 is similar to a photographed image which is previously stored in the storage 170, the controller 130 may not analyze the photographed image again, and may determine a user's location or direction at which a user is located using the previously stored photographed image.

The audio processor 180 may process audio data. For example, the audio processor 180 may perform various processing with respect to audio data, such as decoding, amplification, noise filtering, and the like. The audio data processed by the audio processor 180 may be output to the speaker 190. The speaker 190 may output not only various audio data but also various alarm sounds and voice messages which are processed by the audio processor 180. Furthermore, the display apparatus 100 may include a plurality of speakers 190.

For example, the display apparatus 100 may include speakers 190 on each side of the apparatus, and control the output of audio data to the speakers 190 according to the location at which a partial screen is displayed. For example, if a partial screen is displayed on the first side of the display panel 110, the controller 130 may control the output of audio data corresponding to the content of the partial screen through the speaker 190 that is located at the first side. For example, the controller 130 may increase the volume, decrease the volume, and the like, of the audio signal.

As another example, if content displayed on the partial screen does not include audio data, the controller 130 may decrease the sound of the audio data output from the speaker 190 that is located at the side at which the partial screen is displayed. In other words, if the side at which the partial screen is displayed is adjacent to a user, the controller 130 may decrease a volume of the output of the audio data of the speaker 190 which is located closest to the user's location or direction at which the user is located.

The controller 130 also includes a memory and a central processing unit (CPU) 133. The memory may include a random access memory (RAM) 131, a read only memory (ROM) 132, and the like. The CPU 133 copies various programs stored in the storage 170 to the memory and executes the programs. Accordingly, the aforementioned operations may be performed. The controller also includes a plurality of interfaces 136-1 through 136-n for connecting to external devices.

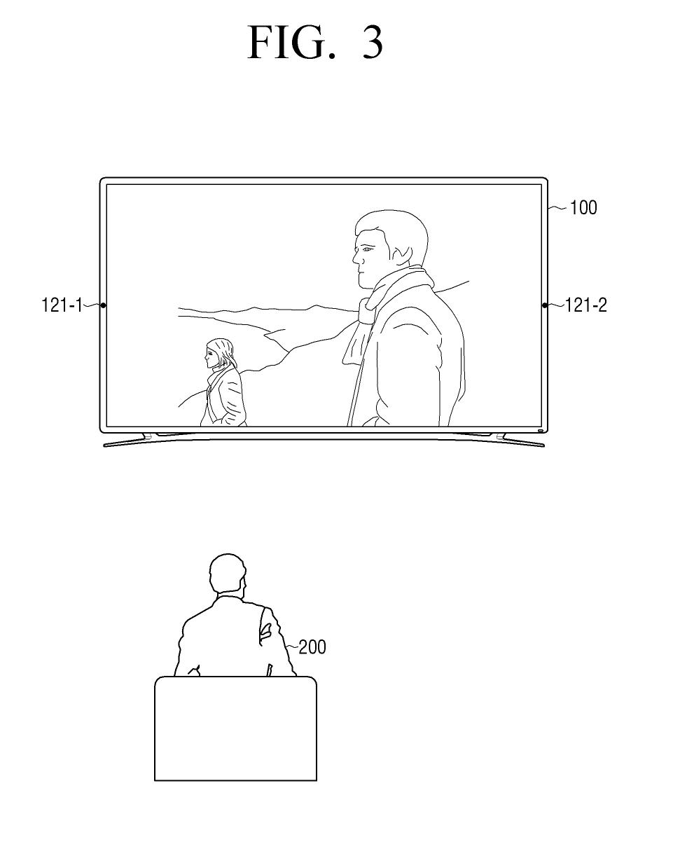

Hereinafter, examples in which the display apparatus 100 displays an OSD menu or a partial screen are described with reference to FIGS. 3 to 7.

FIG. 3 is a diagram illustrating the display apparatus 100 and a user 200 using the same. As illustrated in FIG. 3, the user 200 is located at a position corresponding to a portion of the display apparatus 100. In particular, the user 200 is facing the display apparatus 100 and is located at a left side of the display apparatus. In this example, the display apparatus 100 includes an IR signal receiver 121 at corners of both sides thereof. As another example, the display apparatus 100 may include the IR signal receiver 121 inside thereof and not exposed to the outside.

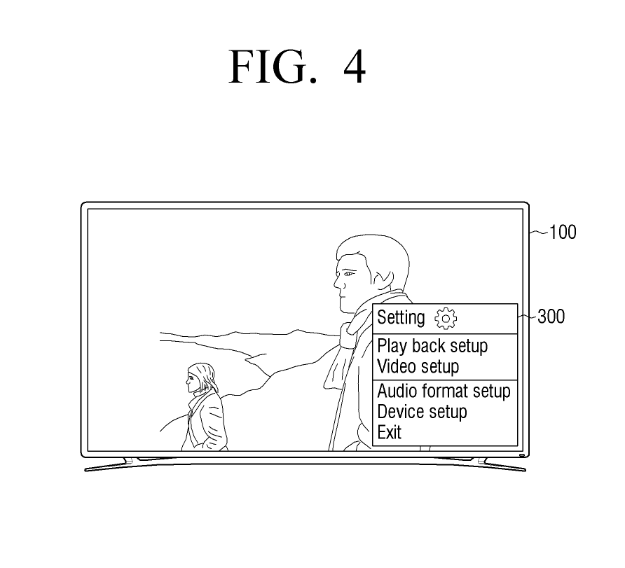

In some cases, the display apparatus 100 has a predetermined location at which a partial screen or an OSD menu is displayed according to a setting. For example, if a setting menu 300 is fixedly displayed at the right side of the user 200 facing the display apparatus 100 as illustrated in FIG. 4, it may be difficult for the user 200 illustrated in FIG. 3 to view and use the displayed setting menu 300. According to various aspects, the display apparatus 100 may change a location at which the setting menu is displayed according to the direction in which the user 200 is located. That is, the display apparatus 100 may adaptively change an area on the screen at which a setting menu or a partial screen is displayed based on a location of a user viewing the display apparatus. Accordingly, the user convenience may be improved.

If the user 200 presses a button on a remote controller to display a setting menu, the display apparatus 100 may detect a remote control signal through a plurality of IR signal receivers 121 at both sides of the display apparatus 100. The embodiment of providing the IR signal receivers 121 at both sides of the display apparatus 100 is merely for purposes of an example, and it should be understood that the display apparatus 100 may have a plurality of IR signal receivers 121 at various locations such as IR signal receivers 121 at four corners, two IR signal receivers at both sides, up and down, and the like.

The display apparatus 100 may compare a time at which the first and the second IR signal receivers 121-1 and 121-2 at both sides receive and detect a remote control signal. The display apparatus 100 may determine a user's location based on the comparison result. For example, the first IR signal receiver 121-1 may be a sensor that is in the left direction from the perspective of the user 200 of FIG. 2 facing the display apparatus 100, and the second IR signal receiver 121-2 may be a sensor in parallel with a corner which is opposite to the corner where the first IR signal receiver 12101 is located.

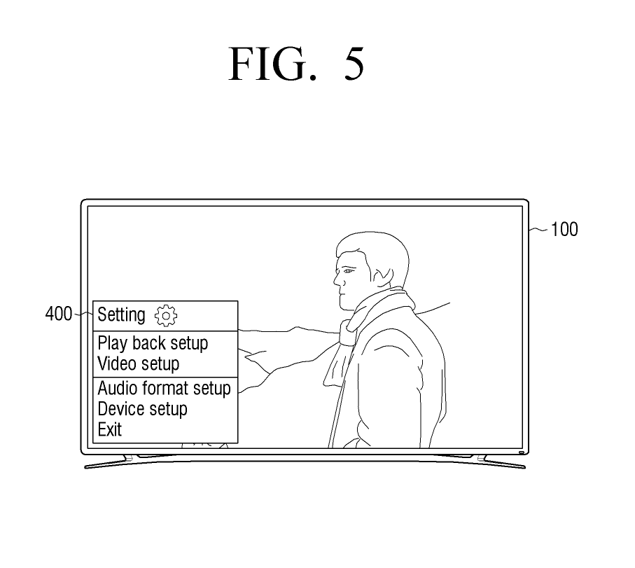

In FIG. 2, the user 200 is positioned to face the display apparatus 100 and is inclined to the left direction. In this example, the first IR signal receiver 121-1 may detect a remote control signal faster than the second IR signal receiver 121-2. Accordingly, the display apparatus 100 may determine that the user is in a direction that is inclined in a direction at which the first IR signal receiver 121-1 is located. In response, the display apparatus 100 may display a setting menu 400 at the first side direction at which the first IR signal receiver 121-1 is located at from among the entire area of the display panel 110 as illustrated in FIG. 5.

As another example, the display apparatus 100 may include a distance sensor to detect a distance at which a user is from the display apparatus. For example, three distance sensors may be included in the lower part of the display panel 110 in a row and in a horizontal direction, and the controller 130 may determine the direction of the user based on the distance sensor which senses a user at the closest distance.

For example, the first through the third distance sensors may be provided in the lower part of the display panel 110 from the left direction to the right direction. The display apparatus 100 may emit infrared rays using infrared ray emitting diodes included in the first to the third distance sensors. Subsequently, the display apparatus 100 may determine whether the user 200 approaches the display apparatus 100 by calculating an angle of incidence at which emitted infrared rays are reflected by the user 200 and received by the distance sensors.

If the user 200 faces the display apparatus 100 and is located at a direction that is to the left of the display apparatus 100, the display apparatus 100 determines that the first distance sensor is closest to the user 200. Accordingly, the display apparatus 100 may display the setting menu 400 at an area that is close to or that corresponds to the first distance sensor within the display panel 110.

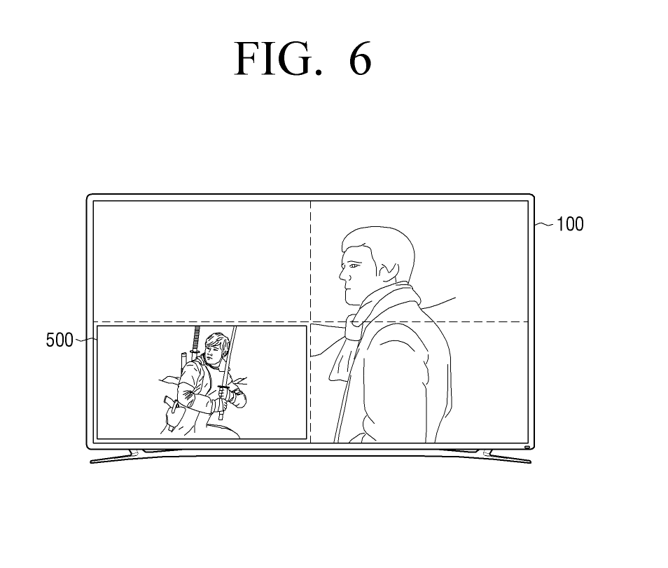

The display apparatus 100 may divide the display panel 110 into a plurality of areas, and display a partial screen on an area according to the determined user's location or direction at which a user is located. For example, if the display apparatus 100 has the IR signal receiver 121 or a distance sensor disposed in up, down, left and right directions with respect to the display panel 110 as described above, and the display panel 110 is divided into four areas as illustrated in FIG. 6, the display apparatus 100 may detect the direction at which the user 200 is located, and display a partial screen in the lower left side corresponding to the location of the user. In particular, FIG. 6 illustrates an example in which an application 500 such as a game is displayed in a partial screen.

If an interactive application such as a game is executed and displayed on a partial screen, the user 200 may feel inconvenience if the user 200 is not close to that part of the screen. Accordingly, to improve user convenience and allow the user 200 to perform instant interaction, the display apparatus 100 may display the application 500 such that the direction of the application 500 corresponds to the direction at which the user 200 is located.

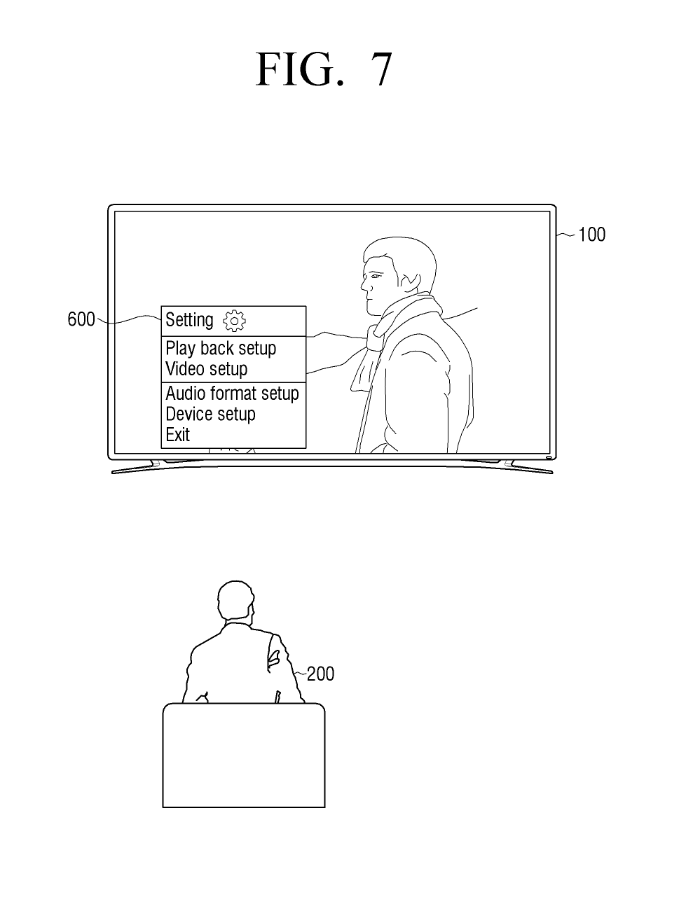

As another example, even if the display panel 110 is not divided into a plurality of areas, the display apparatus 100 may display a partial screen on an area of the display panel 110 as illustrated in FIG. 7.

In other words, the display apparatus 100 may calculate the relative difference between a remote control signal sensed by the first and the second IR signal receivers 121-1 and 121-2, and display a setting menu 600 in a corresponding location. As another example, the display apparatus 100 may include a plurality of distance sensors that determine a user's location or direction at which a user is located according to the distance from the user sensed by each distance sensor, and display the setting menu 600 in the corresponding location. As another example, the display apparatus 100 may include a camera 122. Accordingly, the display apparatus 100 may analyze an image photographed by the camera 122, and determine the location at which the user is located.

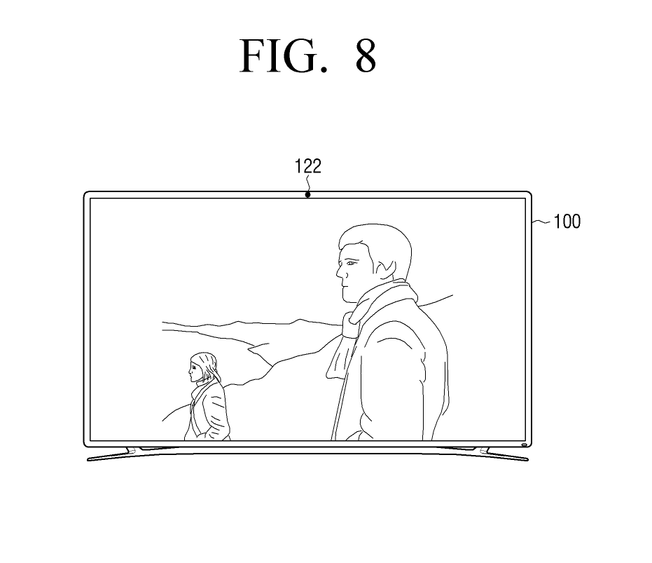

Hereinafter, examples of determining the user's location or direction at which a user is located using the camera 122 are described with reference to FIGS. 8 through 11.

As illustrated in FIG. 8, the display apparatus 100 includes camera 122 on an area above the screen. The camera 122 may be connected to the display apparatus 100 through a connector such as a USB module. As another example, the camera 122 may be built into or otherwise included in the display apparatus 100. An image may be captured by the camera 122, and the controller 130 may determine a direction at which a user with a remote controller is located by analyzing the photographed image.

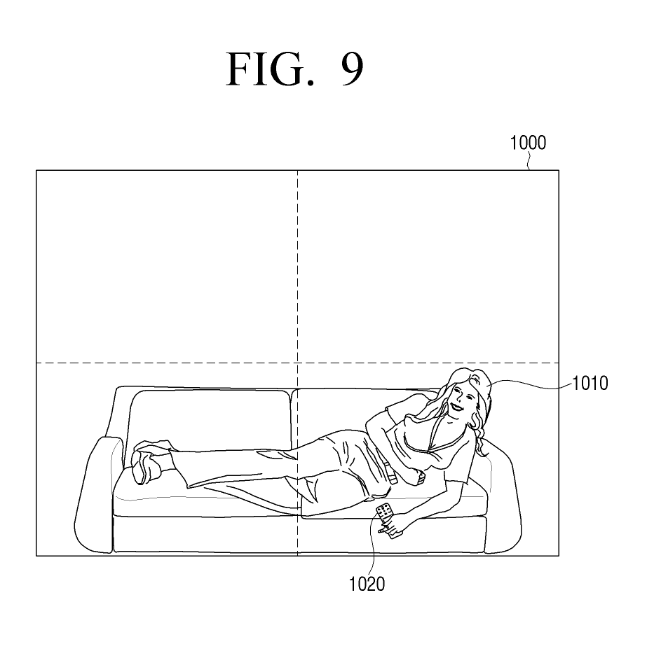

FIG. 9 is a view illustrating a photographed image 100 according to an exemplary embodiment. By analyzing the photographed image 1000, the controller 130 may determine that a face of the user 1010 is displayed at a lower part of one side of the display panel 110 in an example in which the display panel 110 is divided into four areas. Accordingly, the controller 130 may display the OSD menu 400 according to a determined location at which the face of the user is located as illustrated in FIG. 5.

FIG. 9 illustrates an example in which only one user 1010 is photographed. As another example, a plurality of users may be viewing the display apparatus 100, and the plurality of users may be photographed by the camera 122. In this case, the controller 130 may determine that a plurality of users are viewing the display apparatus 100, and display an OSD menu or a partial screen at a predetermined location.

When an OSD menu is displayed, a setting command may be received through a remote controller. Accordingly, the controller 130 may determine a location of a remote controller 1020 by analyzing a photographed image, and determine that there is a user that has the remote controller 1020. In this example, the controller 130 may control the display panel 110 to display the OSD menu according to a direction at which the user having the remote controller 1020 is located.

The method of analyzing a photographed image is further described herein. The display apparatus 100 may divide a photographed image into a plurality of blocks in horizontal and vertical directions. After detecting a property value of pixels included in each block, the display apparatus 100 may compare the property value with those of the surrounding blocks to determine whether the blocks include the same object. The display apparatus 100 may detect an edge portion of each object by performing the above determination process for each block. For example, the display apparatus 100 may detect a user's face area, eyeball area, iris area, iris center coordinates sequentially in consideration of color, shape, size, and the like, of each area which is distinguished by the edge part. Various algorithms and models may be applied in the detection process.

The display apparatus 100 may use a selective attention model with respect to a user image. For example, the display apparatus 100 may detect a face area by applying a Saliency Map (SM) model. The display apparatus 100 may detect an eyeball area using an Adaboost algorithm and applying it to the detected face area, and may detect a pupil area again from the detected eyeball area. After detecting center coordinates of the detected pupil, the display apparatus 100 may map a location of the center coordinates with the screen displayed on the display panel 110. Accordingly, a point on the screen at which the center coordinates of the pupil are directed to may be determined.

Accordingly, the display apparatus 100 may display a partial screen at a location on the display that corresponds to the direction at which the face of a user having the remote controller 1020 is detected. For example, the display apparatus 100 may display a partial screen on an area in an entire area of the display panel 110 to correspond to the direction at which the user's face is detected. As another example, the display panel 110 may be divided into a plurality of areas, and the display apparatus 100 may display a partial screen on an area corresponding to the user's face from among the plurality of areas.

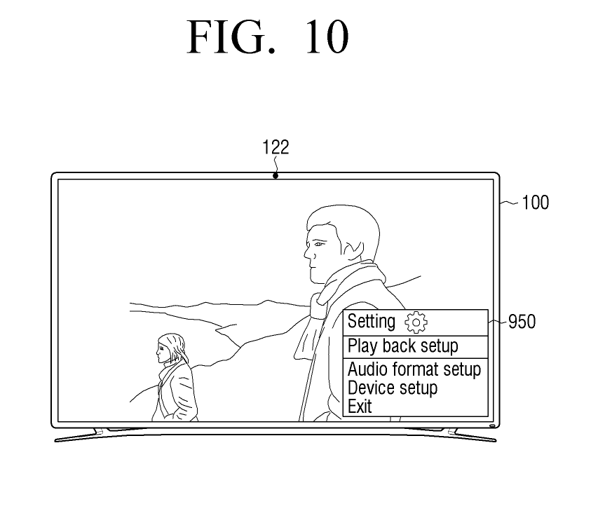

The controller 130 may further analyze a posture of a user who is viewing the display apparatus 100 by analyzing a photographed image. For example, the controller 130 may determine whether a user is in a standing position or a sitting position while they are viewing the display apparatus 100. For example, if it is determined that a user is using the display apparatus 100 as the user faces the display apparatus 100 and sits towards a left direction of the screen based on analysis of a photographed image, the controller 130 may display an OSD menu 950 as illustrated in FIG. 10.

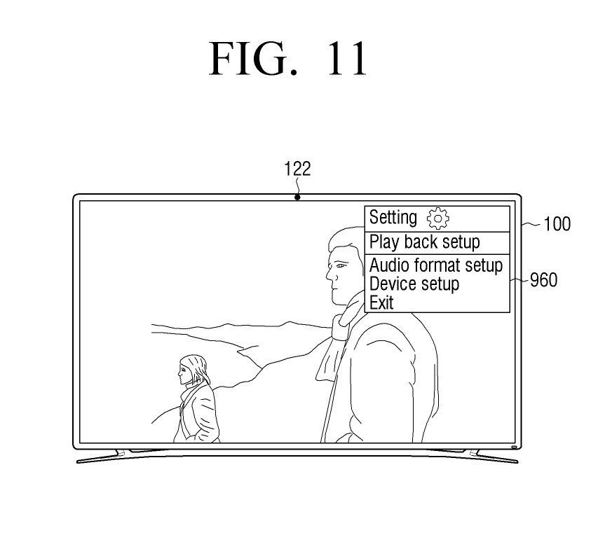

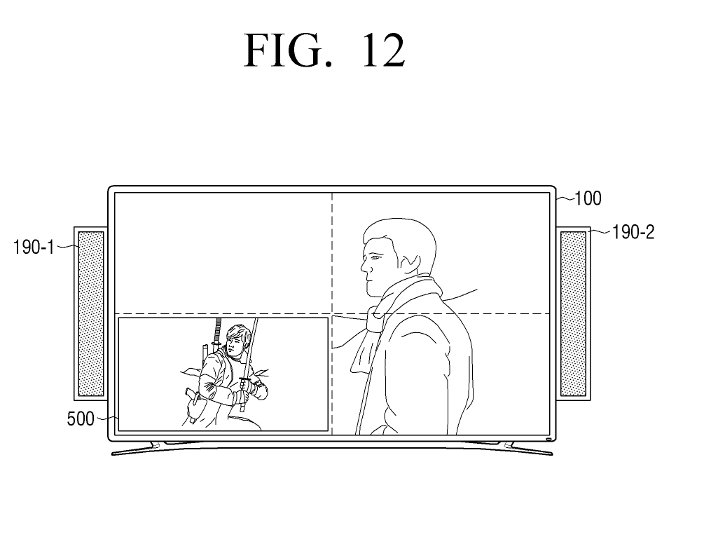

As another example, if it is determined that a user is using the display apparatus 100 as the user faces the display apparatus 100 and stands towards a right direction (or sits on a high chair), the controller 130 may display an OSD menu 960 as illustrated in FIG. 11.

The display apparatus 100 may also adjust an output level of an audio signal that is output from the plurality of speakers 190 according to the determined user's location or direction at which the user is located. For example, if the application 500 displayed on a partial screen includes an audio signal, the display apparatus 100 may increase an audio signal output from the first speaker 190-1 which is near or corresponds to the location of the partial screen at which the application 500 is displayed.

However, this is only an example, and if an image displayed on a partial screen does not include an audio, the display apparatus 100 may output an audio signal included in an entire image of the display apparatus 100. Therefore, the display apparatus 100 may decrease the audio output signal of the first speaker 190-1 which is close to the determined user's location or direction at which the user is located, and increase the audio output signal of the second speaker 190-2 which is farther away from the determined user's location or direction at which the user is located. According to the above-described display apparatus 100, a user may use a partial screen which is displayed closer to the user in the display panel 110.

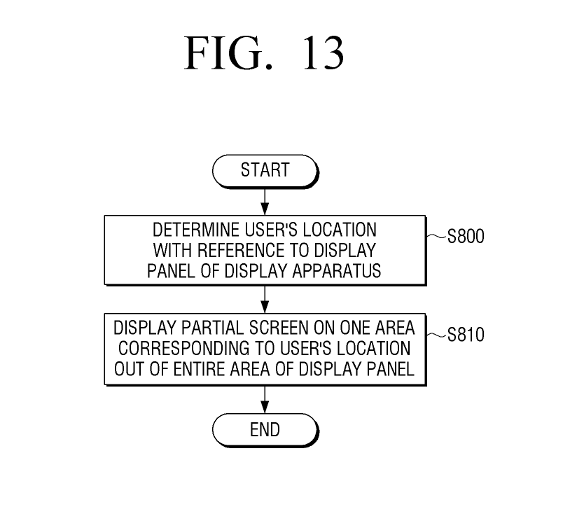

FIG. 13 is a flowchart illustrating a method of displaying a partial screen of the display apparatus 100 according to an exemplary embodiment.

Referring to FIG. 13, the display apparatus 100 determines the user's location or direction at which a user is located with reference to a display panel (S800). For example, the display apparatus 100 may include a plurality of IR signal receivers, and the display apparatus 100 may determine the user's location or direction at which a user is located according to an order in which the plurality of IR signal receivers detect a remote control signal.

The display apparatus 100 may include IR signal receivers 121 at both sides thereof, and a remote control signal is received through the IR signal receivers 121. Accordingly, the display apparatus 100 may compare times at which the signal is received at the IR signal receivers 121 and determine the direction where a user is located. For example, if a first IR signal receiver on the first side of the display apparatus 100 receives a remote control signal before a second IR signal receiver on the second side of the display apparatus 100 receives a remote control signal by an amount of time that is greater than a threshold time, the display apparatus 100 may determine that a user is located in the direction of the first side.

Alternatively, if the first IR signal receiver on the first side of the display apparatus 100 receives a remote control signal after the second IR signal receiver on the second side of the display apparatus 100 receives a remote control signal by an amount of time that is greater than a threshold time, the display apparatus 100 may determine that a user is located in the direction of the second side.

As another example, if the difference in time between when the first IR signal receiver and the second IR signal receiver receive the signals is less than the threshold amount of time, the display apparatus 100 may determine that the user is located in a direction corresponding to the center of the display apparatus 100.

If the display apparatus 100 includes a camera, the display apparatus 100 may determine the user's location or direction at which a user is located by analyzing an image photographed by the camera. For example, the display apparatus 100 may determine the user's location or direction at which a user is located with reference to the face of the user by analyzing the image photographed by the camera. If a plurality of users are photographed in a photographed image, the display apparatus 100 may determine the direction at which a user having a remote controller is located.

If the display apparatus 100 includes a distance sensor, the display apparatus 100 may determine the user's location or direction at which a user is located based on a sensing result by the distance sensor. For example, the display apparatus 100 may include a plurality of distance sensors. If there are three distance sensors in a row included in the lower part of the display panel 110 in a horizontal direction, the display apparatus 100 may determine that the direction of the distance sensor which senses the user at a closest distance as the user's location or direction at which the user is located.

The display apparatus 100 displays an OSD menu or a partial screen at an area corresponding of the display panel corresponding to the determined direction of the user (S810). For example, if a user command to display an OSD menu is input from a user while a main image is being displayed on the entire area of the display panel, the display apparatus 100 may display the OSD menu on the partial screen. As another example, if a user command to display an application is input from the user while a main image is being displayed on the entire area of the display panel, the display apparatus 100 may display the application on the partial screen.

The display apparatus 100 may divide the entire area of the display panel into a plurality of areas such as three areas, and if it is determined the user is located in the direction of the first side rather than at the center, the display apparatus 100 may display the partial screen at an area on the display panel corresponding to the first side direction. Meanwhile, if it is determined that the user is located in the direction of the second side rather than at the center, the display apparatus 100 may display the partial screen at an area corresponding to the second side direction. However, dividing the entire area of the display panel into three areas is only an example, and the entire area of the display panel may be divided into a different amount of areas, for example, two areas, three areas, four areas, or more.

For example, the display panel may be divided into four areas based on a setting, and the display apparatus 100 may display the partial screen on an area out of the four areas according to the determined user's location direction at which the user is located.

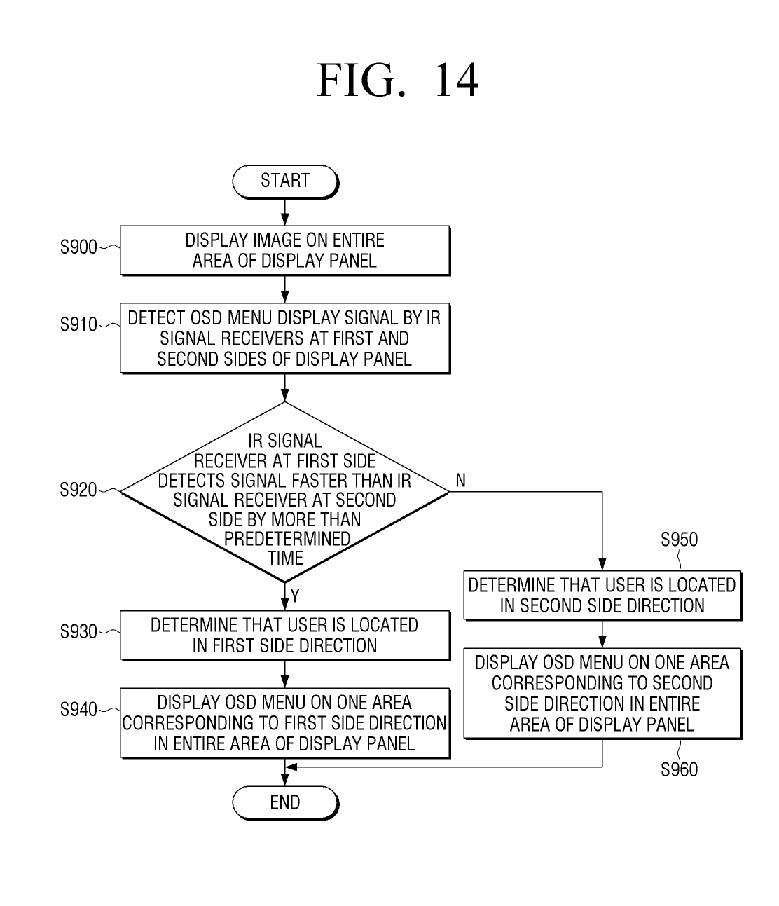

FIG. 14 is a flowchart illustrating a method of controlling an OSD menu display location using a plurality of IR signal receivers that are included in or connected to the display apparatus 100 according to an exemplary embodiment.

Referring to FIG. 14, the display apparatus 100 displays an image on an entire area of a display panel (S900). The display apparatus 100 detects an OSD menu display signal through IR signal receivers at the first side and the second side of the display panel (S910). For example, the display apparatus 100 may include the IR signal receivers at the corners of both sides of the display apparatus 100.

If the IR signal receiver on the first side senses a signal faster than the IR signal receiver on the second side by more than a threshold amount of time (S920-Y), the display apparatus 100 determines that a user is located in the direction of the first side (S930). In response, the display apparatus 100 displays an OSD menu on one area corresponding to the direction of the first side in the entire area of the display panel (S940).

However, if the IR signal receiver on the first side does not sense a signal faster than the IR signal receiver on the second side by more than a threshold time (S920-N), the display apparatus 100 determines that a user is located in the direction of the second side (S950). In response, the display apparatus 100 displays an OSD menu on an area corresponding to the direction of the second side in the entire area of the display panel (S960).

If the difference in time between when the IR signal receivers at the first side and the second side sense an IR signal is not greater than a predetermined amount of time, the display apparatus 100 may determine that a user is located in the center area of the display apparatus 100. In this case, the display apparatus 100 may display an OSD menu at the center of the display panel.

The method of displaying a partial screen of a display apparatus according to the above-described various exemplary embodiments may be coded as software and stored in a non-transitory readable medium. Such a non-transitory readable medium may be mounted in various apparatuses and used.

The non-transitory computer readable medium refers to a medium which may store data semi-permanently or permanently rather than storing data for a short time such as a register, a cache, and a memory and may be readable by an apparatus. Specifically, the non-transitory recordable medium may be CD, DVD, hard disk, Blu-ray disk, USB, memory card, ROM, etc.

The foregoing embodiments and advantages are merely exemplary and are not to be construed as limiting the present invention. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method of controlling a display apparatus, the method comprising:
determining a user's location with reference to a display panel of the display apparatus; and
displaying an on-screen display (OSD) menu or a partial screen on an area of the display panel corresponding to the determined user's location.

2. The method as claimed in claim 1, wherein the determining comprises, in response to a remote control signal being received from a plurality of infrared (IR) signal receivers located at both sides of the display apparatus, comparing a time at which the signal is received at each of the plurality of IR signal receivers, and determining the user's location based on the comparing.

3. The method as claimed in claim 2, wherein, in response to a first IR signal receiver at a first side of the display apparatus receiving the remote control signal faster than a second IR signal receiver at a second side of the display apparatus receiving the remote control signal, by more than a threshold amount of time, the determining comprises determining that the user is located in a direction of the first side, and in response to the second IR signal receiver receiving the remote control signal faster than the first IR signal receiver, by more than the predetermined amount of time, the determining comprises determining that the user is located at the second side of the display apparatus.

4. The method as claimed in claim 1, wherein the determining comprises:
photographing the user using a camera; and
determining a user's location by analyzing the photographed image of the user.

5. The method as claimed in claim 1, wherein the determining comprises:
sensing a distance between the display apparatus and the user using at least one distance sensor; and
determining a distance sensor closest to the user as a location of the user.

6. The method as claimed in claim 1, further comprising:
adjusting a volume of an audio signal output from first and second speakers at both sides of the display apparatus according to a user's location.

7. The method as claimed in claim 1, wherein the displaying comprises, in response to receiving a user command to display a setting menu while a main image is being displayed on an entire area of the display panel, displaying the setting menu on a partial screen.

8. The method as claimed in claim 1, wherein the displaying comprises, in response to receiving a user command to display an application while a main image is being displayed on an entire area of the display panel being input, displaying the application on the partial screen.

9. A display apparatus comprising:
a display panel configured to display an image;
a detector; and
a controller configured to determine a user's location with reference to the display panel according to a result of a detection by the detector, and display an on-screen display (OSD) menu or a partial screen on an area corresponding to the determined user's location.

10. The display apparatus as claimed in claim 9, wherein the detector further comprises:
a plurality of infrared (IR) signal receivers, and
in response to a remote control signal being received by a plurality of IR signal receivers located at both sides of the display apparatus, the controller is configured to compare a time at which the signal is received at each of the plurality of IR signal receivers and determine the user's location based on the comparison.

11. The display apparatus as claimed in claim 10, wherein the controller is configured to, in response to a first IR signal receiver at a first side of the display apparatus receiving the remote control signal faster than a second IR signal receiver at a second side of the display apparatus receiving the remote control signal, by more than a threshold amount of time, determine that the user is located in a direction of the first side, and in response to the second IR signal receiver receiving the remote control signal faster than the first IR signal receiver, by more than the threshold amount of time, determine that the user is located at the second side of the display apparatus.

12. The display apparatus as claimed in claim 9, wherein the detector further comprises a camera,
wherein the controller is configured to control the camera to photograph the user, and determine a user's location by analyzing the photographed image of the user.

13. The display apparatus as claimed in claim 9, wherein the detector further comprises at least one distance sensor,
wherein the controller is configured to sense a distance from the user using the at least one distance sensor, and determine a distance sensor closest to the user as a user's location.

14. The display apparatus as claimed in claim 9, further comprising a plurality of speakers,
wherein the controller is configured to adjust a volume of an audio signal output from first and second speakers from among the plurality of speakers according to a user's location.

15. The display apparatus as claimed in claim 9, wherein the controller is configured to, in response to receiving a user command to display a setting menu while a main image with respect to an entire area of the display panel is being displayed, display the setting menu on the partial screen.

16. The display apparatus as claimed in claim 9, wherein the controller is configured to, in response to receiving a user command to display an application while a main image is being displayed on an entire area of the display panel, display the application on the partial screen.

17. An apparatus for processing an image, the apparatus comprising:
a detector configured to determine an area on a display, from among a plurality of areas, which corresponds to a location of a user; and
a controller configured to output at least one of an on-screen display (OSD) menu and a partial screen at the area of the display that corresponds to the location of the user.

18. The apparatus of claim 17, wherein the controller is configured to divide the display into the plurality of areas.

19. The apparatus of claim 17, wherein the controller is configured to output the at least one of the OSD and the partial screen at only the area on the display which corresponds to the location of the user.

20. The apparatus of claim 17, wherein the controller is configured to output audio to a speaker based on the area of the display which corresponds to the location of the user.
